(19) United States
(12) Patent Application Publication
(10) Pub. No.: US 2007/0172723 A1
(43) Pub. Date: Jul. 26, 2007

(54) Lithium-ion battery protector device

(75) Inventor: Hong-Fang Chen, Sijhih City (TW)

Correspondence Address: TROXELL LAW OFFICE PLLC, SUITE 1404, 5205 LEESBURG PIKE, FALLS CHURCH, VA, 22041, US

(73) Assignee: Leton Technology Co., Ltd.

(21) Appl. No.: 11/335,550

(22) Filed: Jan. 20, 2006

(51) Int. Cl. H01M 2/34; H01M 10/48

(52) U.S. Cl. 429/61; 429/90

(57) ABSTRACT

A lithium-ion battery protector device is composed of a lithium-ion battery which is serially connected to form a lithium-ion battery set. When the throttle signal of lithium-ion battery reaches to a low potential, the battery protector will enter into a protection mode. When the throttle signal of lithium-ion battery reaches to a stable potential, the throttle signal of the lithium-ion battery will be the same as that of a receiving device. The battery protector can monitor a charging and discharging status of each lithium-ion battery through a light indicator and a control circuit. When the receiving device receives the throttle signal of lithium-ion battery, the magnitude of throttle signal of the receiving device can be effectively controlled through an automatic identification of the throttle signal by the battery protector, such that the lithium-ion battery will not be excessively charged and discharged.

### BACKGROUND OF THE INVENTION

(a) Field of the Invention

The present invention relates to a lithium-ion battery protector device, and more particularly to a lithium-ion battery protector device which enables a lithium-ion battery set to be serially connected to a battery protector with a branch connector, so as to provide a protection of charging and discharging to each lithium-ion battery.

(b) Description of the Prior Art

Referring to FIG. 1 and FIG. 2, it shows an ordinary lithium-ion battery A which is serially connected. As a variation of feature of each lithium-ion battery A, when the lithium-ion battery A is used after a multiple times of charging and discharging, an attenuation and an aging from a leakage of battery fluid will be formed to each lithium-ion battery A, such that every serially connected lithium-ion battery A will have different electronic property. However, as each lithium-ion battery A can be filled with electric energy yet without being able to efficiently control the charging and discharging status of the lithium-ion battery A, when any one of the serially connected lithium-ion batteries A is charged and discharged to a critical point, a protection circuit A1 of the lithium-ion battery A will proceed with a cut-off action, such that other lithium-ion batteries A will not be charged further, and a premature cut-off condition will occur during a process of discharging, thereby resulting in a reduction of time of operation to the lithium-ion battery A and a reduction of lifetime of usage of charging and discharging to the lithium-ion battery A.

### SUMMARY OF THE INVENTION

The present invention is to provide a lithium-ion battery protector device, and more particularly to a lithium-ion battery protector device which enables a lithium-ion battery set to be serially connected to a battery protector with a branch connector, so as to provide a protection of charging and discharging to each lithium-ion battery. In addition, the battery protector can monitor a charging and discharging status of each lithium-ion battery through a light indicator, and a receiving device and an electronic gearbox can be used to automatically reduce and stop outputting current and voltage in accordance with the charging and discharging status of each lithium-ion battery, through a control circuit of the battery protector, thereby effectively preventing the lithium-ion battery from being excessively discharged.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional application.

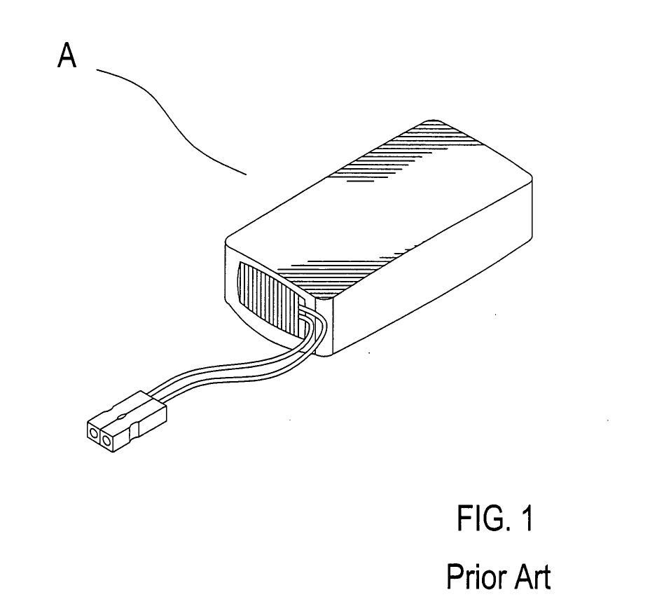

FIG. 2 shows a cutaway view of a conventional application.

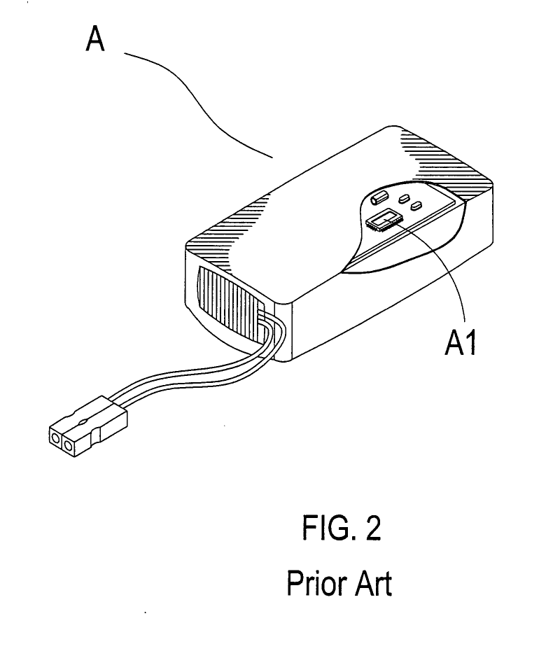

FIG. 3 shows a perspective view of the present invention.

FIG. 4 shows a block diagram of the present invention.

FIG. 5 shows a circuit diagram of the present invention.

FIG. 6 shows a schematic view of an implementation of the present invention.

FIG. 6a shows a schematic view of a local blow-up of the present invention.

### DETAILED DESCRIPTION OF THE PREFERRED EMBODIMENTS

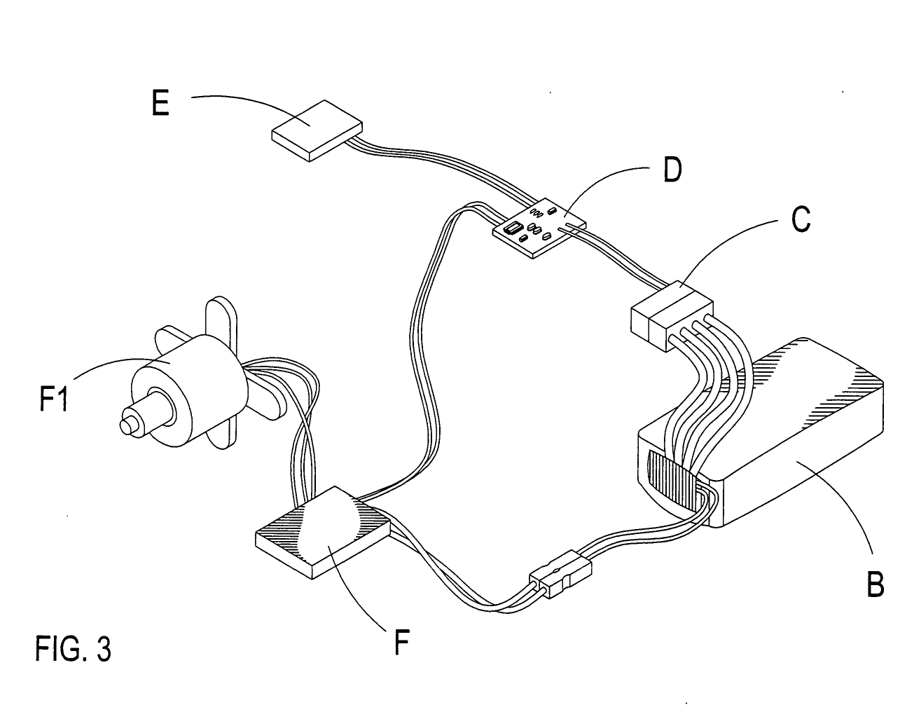

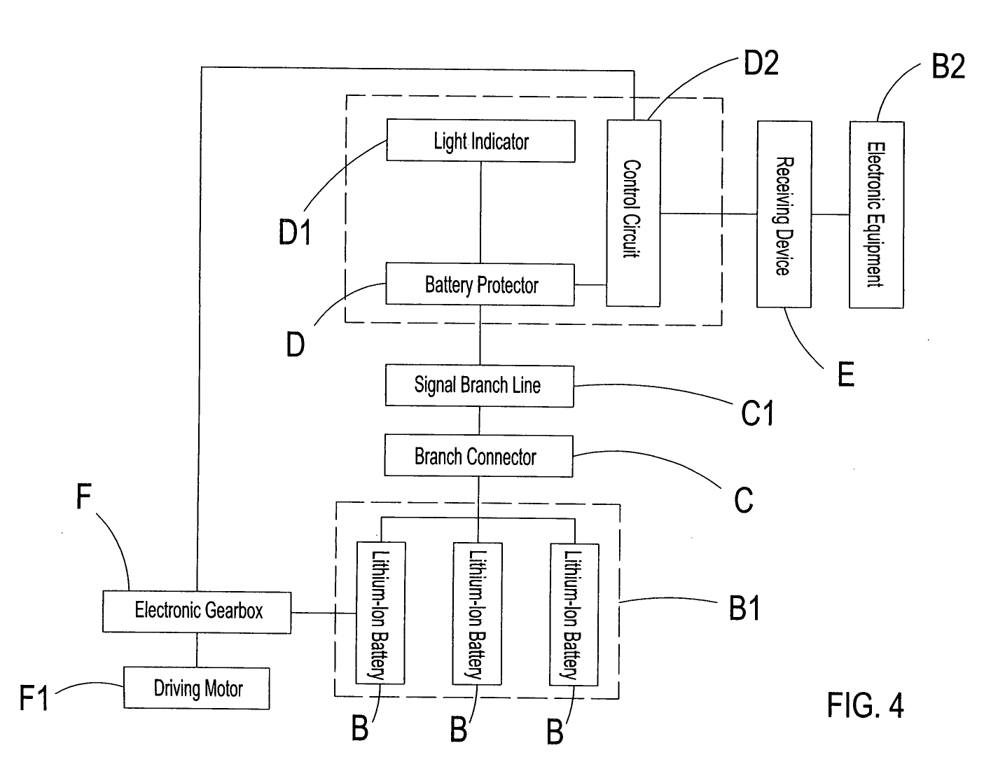

The present invention is to provide a lithium-ion battery protector device, as shown in FIG. 3 and FIG. 4, which includes a lithium-ion battery B, a branch connector C, a battery protector D, a receiving device E, an electronic gearbox F, and a motor F1, wherein the lithium-ion battery is serially connected to form a lithium-ion battery set B, and each lithium-ion battery B1 can be connected to the battery protector D through the branch connector C respectively, to provide a protection of charging and discharging for each lithium-ion battery B1.

Through a signal line C1, the branch connector C can connect each serially connected lithium-ion battery set B to the battery protector D for performing an automatic identification. When a throttle signal of the lithium-ion battery B1 reaches to a low potential, a protection mode of blackout can be reached through the battery protector D.

The battery protector D can monitor the charging and discharging status of each lithium-ion battery through a light indicator D1 and a control circuit D1. When the receiving device E receives the throttle signal, a magnitude of throttle signal output can be effectively controlled through an identification of the battery protector D.

On the other hand, when the receiving device E receives the throttle signal, the magnitude of throttle signal of electronic gearbox F can be effectively controlled through the control circuit D2 installed by the battery protector D, such that the lithium-ion battery B will not be excessively charged and discharged, thereby reducing a lifetime of usage of the lithium-ion battery B.

In addition, the electronic gearbox F and the motor F1 are connected to the battery protector D and the lithium-ion battery set B, and can automatically reduce or stop outputting the throttle signal of electronic gearbox F after identifying the throttle signal by the battery protector D, according to the charging and discharging status of each lithium-ion battery B1, so as to enable electronic equipment B2 to achieve a sound operation and to prolong a lifetime of usage of the lithium-ion battery set B.

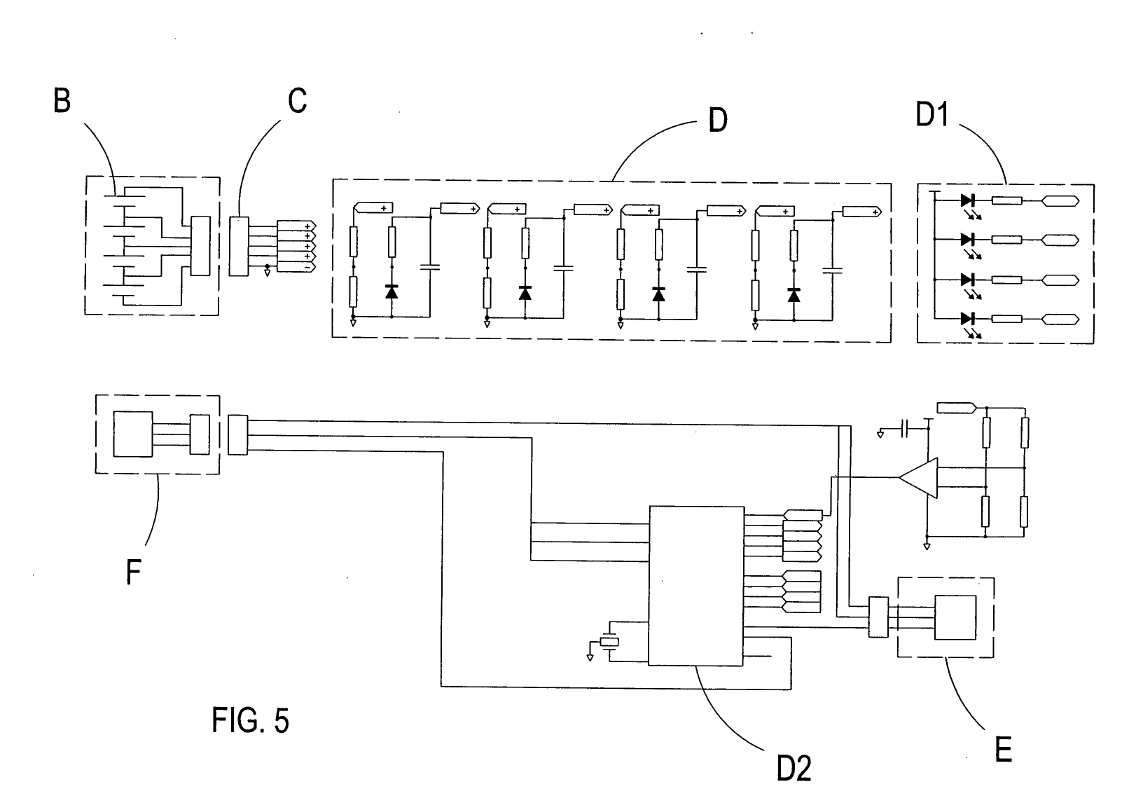

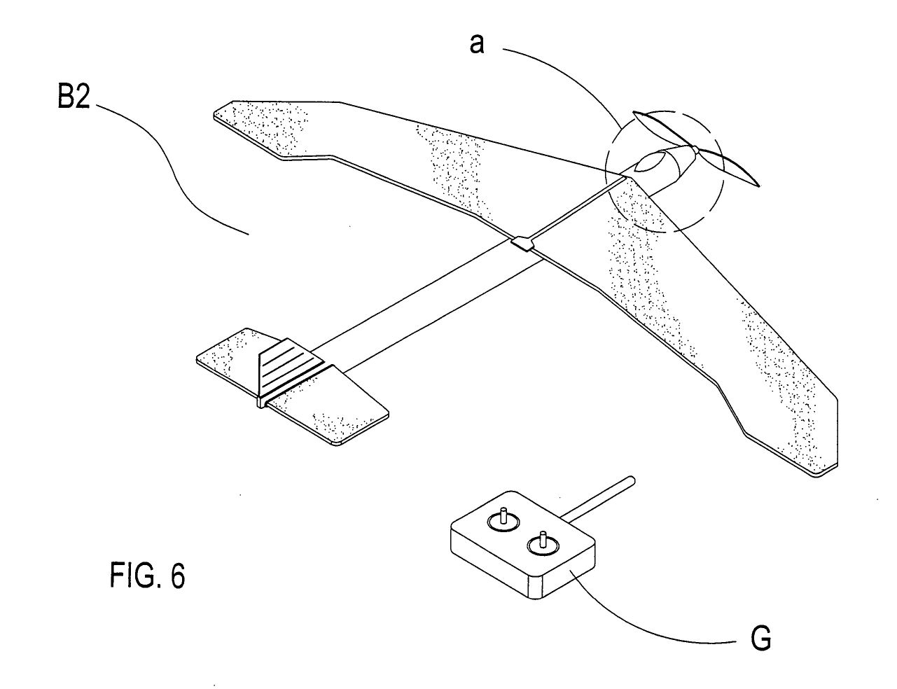

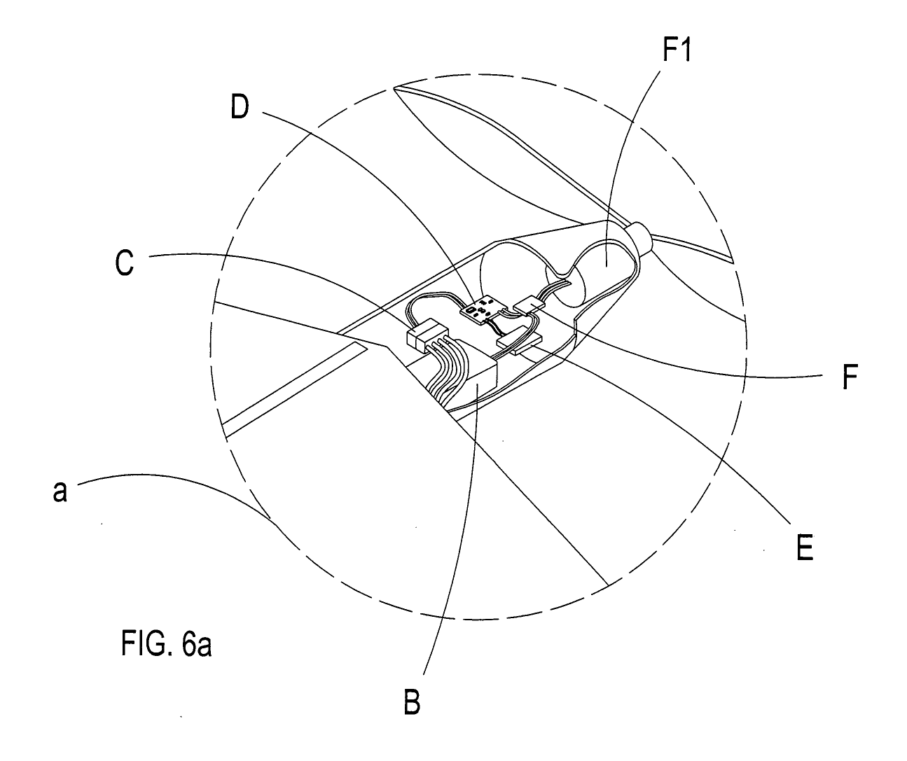

Referring to FIG. 4, FIG. 5, FIG. 6, and FIG. 6a, a lithium-ion battery B1 is serially connected to form a lithium-ion battery set B, and each lithium-ion battery B1 can be connected to a battery protector D through a branch connector C and a branch signal line C1 respectively, to provide a protection of charging and discharging for the lithium-ion battery set B. In addition, through a control of throttle signal, the serially connected lithium-ion battery set B can be used to replace electronic equipment B2 of engine power, so as to enable the electronic equipment B2 to generate an operation and application of the throttle signal.

The battery protector D can monitor the charging and discharging status of each lithium-ion battery B1 through a light indicator D1 and a control circuit D2. When a receiving device E receives the throttle signal of a transmitting device G, a magnitude of throttle signal of an electronic gearbox F can be controlled through an identification of throttle signal by the battery protector D, such that the lithium-ion battery B will not be excessively charged and discharged.

The branch connector C can perform an automatic identification of throttle signal to each separately connected lithium-ion battery B1 through the battery protector D. When a voltage of lithium-ion battery set B reaches to a low potential, the battery protector D will enter into a protection mode of lithium-ion battery set B, thereby effectively reducing the magnitude of throttle signal of electronic gearbox F. On the other hand, when the voltage of lithium-ion battery set B reaches to a stable potential, the throttle signal of electronic gearbox F will be the same as the potential of throttle signal of the receiving device E, thereby effectively prolonging a lifetime of usage of the serially connected lithium-ion battery set B and reducing a cost of consumption of the lithium-ion battery B1.

The electronic gearbox F and a motor F1 are connected to the battery protector D and the lithium-ion battery set B, and can automatically reduce or stop outputting the throttle signal through an identification of the throttle signal by the battery protector D, according to the charging and discharging status of each lithium-ion battery B, so as to enable the electronic equipment B2 to achieve a sound operation and to effectively prolong a lifetime of usage of the serially connected lithium-ion battery set B.

Through the branch connector C, the battery protector D can further connect the lithium-ion battery B to a notebook computer, a mobile phone, a wireless transceiver, a remotely-controlled airplane, a remotely-controlled car, a driving motor, and other related electronic equipment using the lithium-ion battery B as power and the throttle signal as an output, so as to enable the lithium-ion battery B to be applied to the electronic equipment B2, thereby achieving a sound operation, reducing a weight of lithium-ion battery B, and effectively preventing the lithium-ion battery B from being excessively discharged.

To further manifest the advancement and practicability of the present invention, the present invention is compared with a conventional application as below:

Shortcomings of a Conventional Application
b 1. The lithium-ion battery is installed with a protection circuit, which is easy to result in an increase of weight and cost.
2. If any lithium-ion battery reaches to a critical point, it is easy to result in that other lithium-ion batteries will not be charged further.
3. When the lithium-ion battery is suffered from multiple times of charging and discharging, they are easy to be attenuated and aging from a leakage of battery fluid.

Advantages of the Present Invention
1. The battery protector and the serially connected battery set can be separately connected through the branch connector.
2. The branch connector can provide a protection of charging and discharging for each lithium-ion battery.
3. The battery protector is provided with the control circuit which can be used to monitor the throttle signal of the receiving device.
4. The receiving device can effectively prevent the lithium-ion battery from being excessively discharged, through the battery protector.
5. The electronic gearbox is connected to the battery protector and the serially connected battery set.
6. According to item 5, it can automatically reduce or stop outputting the signal, according to the charging and discharging status.
7. It is provided with advancement and practicability.
8. It is provided with an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A lithium-ion battery protector device comprising a lithium-ion battery, a branch connector, a battery protector, a receiving device, an electronic gearbox, and a motor, wherein the lithium-ion battery is serially connected to form a lithium-ion battery set and each lithium-ion battery can be connected to the battery protector respectively, through the branch connector, to provide a protection of charging and discharging for each lithium-ion battery; the branch connector being able to perform an identification of throttle signal to each connected lithium-ion battery through the battery protector, such that when a voltage of lithium-ion battery reaches to a low potential, the battery protector will enter into a protection mode of lithium-ion battery to reduce a magnitude of throttle signal of the electronic gearbox, and when the voltage of lithium-ion battery reaches to a stable potential, the potential of throttle signal of the electronic gearbox will be the same as that of the receiving device; the battery protector being able to monitor the charging and discharging status of each lithium-ion battery through a light indicator, such that when the receiving device receives the throttle signal of lithium-ion battery, the magnitude of throttle signal of the electronic gearbox can be effectively controlled through an automatic identification by the battery protector, thereby preventing the lithium-ion battery from being excessively charged and discharged to reduce a lifetime of usage of the lithium-ion battery; the electronic gearbox and the motor being connected to the battery protector and automatically reducing or stopping outputting the throttle signal through the battery protector, according to the charging and discharging status of each lithium-ion battery, thereby enabling electronic equipment to achieve a sound operation and prolonging a lifetime of usage of the serially connected lithium-ion battery set.

2. The lithium-ion battery protector device according to claim 1, wherein the battery protector can further connect the lithium-ion battery to a notebook computer, a mobile phone, a wireless transceiver, a remotely-controlled airplane, a remotely-controlled car, a driving motor, and other related electronic equipment using the lithium-ion battery as power, to effectively prolong a lifetime of usage of the lithium-ion battery, through the branch connector.

3. The lithium-ion battery protector device according to claim 1, wherein the battery protector and the lithium-ion battery can be further configured as a serial printed circuit, a parallel printed circuit, a vertical signal line, a branch signal line, and other related device which can output the charging and discharging signal of the lithium-ion battery to a user by configuring the battery protector and the lithium-ion battery as an integral and separate connection.

4. The lithium-ion battery protector device according to claim 1, wherein the throttle signal of receiving device can be further a voltage signal, a pulse signal, a digital signal, an analog signal, and other related signal which can be controlled through a wired and wireless signal transmission method.
